(19) United States
(12) Patent Application Publication
(10) Pub. No.: US 2022/0343296 A1
(43) Pub. Date: Oct. 27, 2022

(54) SYSTEMS, METHODS, AND STORAGE MEDIA FOR SETTLING TRANSACTION PAYMENTS

(71) Applicant: Wedge Financial, Inc., Wimberley, TX (US)

(72) Inventors: William Wythe Roberts, Wimberley, TX (US); Alexander Hartmut Duvall, Austin, TX (US)

(21) Appl. No.: 17/725,601

(22) Filed: Apr. 21, 2022

Related U.S. Application Data
(60) Provisional application No. 63/180,132, filed on Apr. 27, 2021.
(60) Provisional application No. 63/253,337, filed on Oct. 7, 2021.

(51) Int. Cl. G06Q 20/06; G06Q 40/04; G06Q 20/38; G06Q 20/02

(52) U.S. Cl. CPC G06Q 20/0658; G06Q 40/04; G06Q 20/389; G06Q 20/02; G06Q 20/351

(57) ABSTRACT

Systems, methods, and storage media for settling transaction payments by linking third-party financial accounts to user profiles, issuing payment cards to users, and facilitating real-time physical and virtual payments to vendors. The user profiles display available assets for purchase by the users who submit requests to execute physical or virtual transactions. Once the request is submitted, the user's device will display a timestamped notification indicating their currently held assets, their respective account balances for at least one of their third-party financial accounts, or a combination thereof. Users can sell assets, withdraw funds from at least one of their third-party financial accounts, be connected to third-party brokers or third-party cryptocurrency exchanges, and exchange assets to fund their purchases.

### PRIORITY AND RELATED APPLICATIONS

The present Application for Patent claims priority to Provisional Application No. 63/253,337 entitled “SYSTEMS, METHODS, AND STORAGE MEDIA FOR SETTLING TRANSACTION PAYMENTS” filed Oct. 7, 2021, and Provisional Application No. 63/180,132 entitled “FINANCIAL LEDGER/ROUTING METHOD FOR PROVIDING INSTANTANEOUS LIQUIDITY OF ASSETS” filed Apr. 27, 2021. Both of these provisional applications are assigned to the assignee hereof and hereby expressly incorporated by reference herein.

### FIELD

The present disclosure relates generally to a system for settling transaction payments. In particular, but not by way of limitation, the present disclosure relates to systems, methods, and apparatuses for settling transaction payments using one or more asset classes or cash in real-time at the point of sale.

### BACKGROUND

The use of payment cards (e.g., credit cards, debit cards), especially through mobile or digital wallets, has increased in popularity since their inception. For instance, many vendors, such as grocery stores, gas stations, etc., now accept payments through mobile or digital wallets storing payment card information, in addition to credit and/or debit cards. A user can simply open a mobile/digital wallet app, such as GOOGLE PAY or APPLE PAY, and tap their smart phone on a point of sale (POS) system operated by a vendor to complete a transaction. Some credit and/or debit cards are also equipped with Near Field Communication (NFC) and/or or Radio Frequency Identification (RFID) technology to allow users to tap their payment cards at a POS system and complete a transaction. While such payment technologies have facilitated in migrating users and vendors from a predominantly cash based system to digital payment systems, current digital payment technologies are still lacking in several regards. Notably, current payment technologies often limit how users pay for items, i.e., through their checking account (e.g., debit cards) or through a credit account (i.e., credit cards). In some circumstances, users may desire more flexibility with regards to how they can purchase items. There is therefore a need in the art for a refined platform for not only simplifying a user's wallet, but also providing the user with greater flexibility with how they can pay for goods and services.

### SUMMARY

Embodiments disclosed herein address the above stated needs by disclosing a method for settling transaction payments, comprising: creating a user profile for a user in a first network; linking at least one financial account to the user profile, wherein one or more of the at least one financial account is a third-party financial account; issuing at least one payment card to the user, wherein the at least one payment card comprises one or more of a virtual payment card and a physical payment card; displaying one or more first assets available to the user for purchase on the user profile; receiving a request from the user to execute a user transaction, wherein the user transaction comprises the user utilizing one or more of the at least one payment card for executing a purchase at a vendor, either physically or virtually; displaying a timestamped notification on a user device, wherein the timestamped notification comprises an indication of current assets held by the user, an indication of a respective account balance for one or more of the at least one financial account, or a combination thereof; accepting the request from the user to execute the user transaction, wherein the accepting comprises a user input for executing the purchase at the vendor; and executing the purchase, wherein executing the purchase comprises of one or more of: selling at least one asset of the current assets held by the user, withdrawing funds from the at least one financial account, connecting the user to a third-party broker or a third-party cryptocurrency exchange for purchasing at least one of the one or more first assets, and exchanging at least one of the one or more first assets to fund the purchase.

Further disclosed is a system configured for settling transaction payments, the system comprising: one or more hardware processors configured by machine-readable instructions to: create a user profile for a user in a first network; link at least one financial account associated with the user to the user profile, wherein one or more of the at least one financial account is a third-party financial account in one or more other networks distinct from the first network; issue at least one payment card to the user, wherein the at least one payment card comprises one or more of a virtual payment card and a physical payment card; display, on the user profile, one or more first assets available to the user for purchase; receive a request from the user to execute a user transaction, wherein the user transaction comprises the user utilizing one or more of the at least one payment card for executing a purchase at a vendor, either physically or virtually; display a timestamped notification on a user device, wherein the timestamped notification comprises an indication of current assets held by the user, an indication of a respective account balance for one or more of the at least one financial account, an indication of an available line of credit, or a combination thereof; and accept a user input for executing the purchase, wherein executing the purchase comprises of one or more of: sell at least one asset of the current assets held by the user, withdraw funds from the at least one financial account, utilize an available line of credit, connect the user to a third-party broker or a third-party cryptocurrency exchange for purchasing at least one of the one or more first assets, and exchange at least one of the one or more first assets to fund the purchase.

Further disclosed is a non-transient computer-readable storage medium having instructions embodied thereon, the instructions being executable by one or more processors to perform a method for settling transaction payments, the method comprising: creating a user profile for a user in a first network; linking at least one financial account associated with the user to the user profile, wherein each of the at least one financial account is a third-party financial account in another network different from the first network; issuing, to the user, at least one payment card, wherein the at least one payment card comprises one or more of a virtual payment card and a physical payment card; displaying one or more first assets available to the user for purchase; receiving a request for a user transaction, wherein the request is associated with the user using the at least one payment card for conducting a purchase at a vendor; displaying a timestamped notification on a user device associated with the user, wherein the timestamped notification comprises an indication of current assets held by the user that can be used to fund the purchase, an indication of a respective account balance for the at least one financial account, an indication of an available line of credit, or a combination thereof; and accepting a user input for conducting the purchase, wherein conducting the purchase comprises one of: selling at least one asset of the current assets held by the user; withdrawing funds from the at least one financial account; utilizing an available line of credit; and connecting the user to a third-party broker or a third-party cryptocurrency exchange for purchasing at least one of the one or more first assets and exchanging the at least one of the one or more first assets to fund the purchase.

### BRIEF DESCRIPTION OF THE DRAWINGS

The objects, features, and attendant advantages of the present disclosure are fully appreciated as the same becomes better understood when considered in conjunction with the accompanying drawings.

FIG. 1 is a block diagram depicting physical components within a system that may be utilized to settle transaction payments, in accordance with one or more embodiments of the present disclosure;

FIG. 2 is a flowchart depicting a method that may be executed for settling transaction payments, in accordance with one or more embodiments of the present disclosure;

FIG. 3 is a block diagram depicting physical components within a system that may be utilized to settle transaction payments between a user or user and a vendor, according to an embodiment of the present disclosure; and

FIG. 4 is a block diagram depicting physical components within a computer system of an embodiment of the present disclosure, wherein any one or more of the aspects and/or methodologies of the present disclosure may be implemented.

### DETAILED DESCRIPTION

The present disclosure relates generally to a system for settling transaction payments. More specifically, but without limitation, the present disclosure relates to systems, methods, apparatuses, and/or storage media for settling transaction payments using one or more asset classes, such as cash (e.g., debit from a bank account) or credit, in real-time at the point of sale (POS).

Preliminary note: the flowcharts and block diagrams in the following Figures illustrate the architecture, functionality, and operation of possible implementations of systems, methods, and computer program products according to various embodiments of the present invention. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items, however the teaching of the present disclosure inherently discloses elements used in embodiments incorporating technology available at the time of this disclosure.

The detailed descriptions which follow are presented in part in terms of algorithms and symbolic representations of operations on data within a computer memory wherein such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are sometimes described in terms, such as comparing, sorting, selecting, or adding, which are commonly associated with mental operations performed by a human operator. It should be understood that these terms are employed to provide a clear description of an embodiment of the present invention, and no such human operator is necessary, nor desirable in most cases.

This requirement for machine implementation for the practical application of the algorithms is understood by those persons of skill in this art as not a duplication of human thought, rather as significantly more than such human capability. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, wherein some aspects of the algorithm are performed by the circuitry itself rather as a result of an instruction.

Some embodiments of the present invention rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of embodiments herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that client and server each perform distinct, but complementary functions to accomplish a task or provide a service. The client and server accomplish this by exchanging data, messages, and often state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients. In some instances, the term “client” may be used to refer to a user device, such as a laptop, a smartphone, a NetBook, etc.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

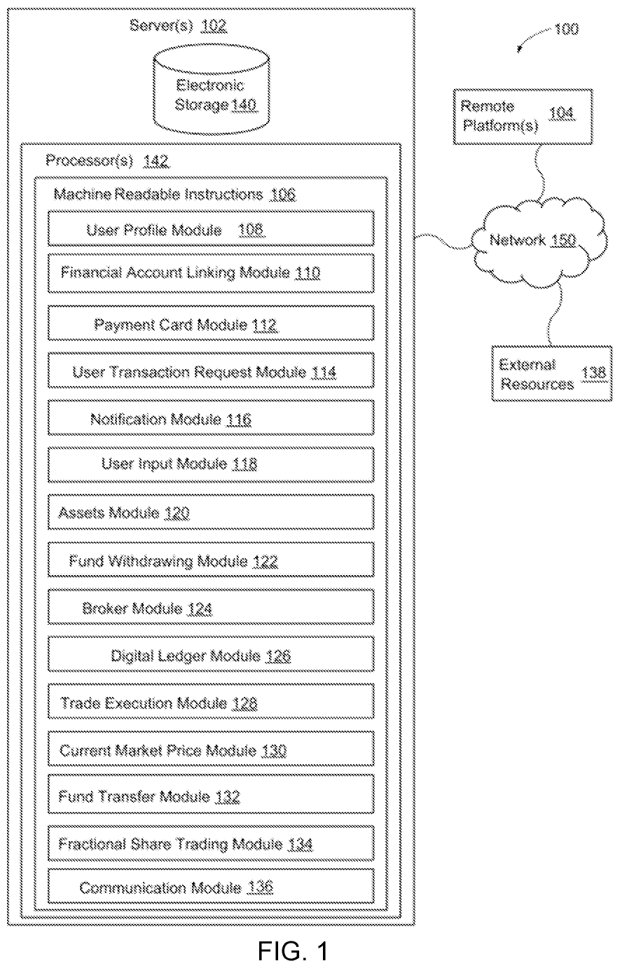

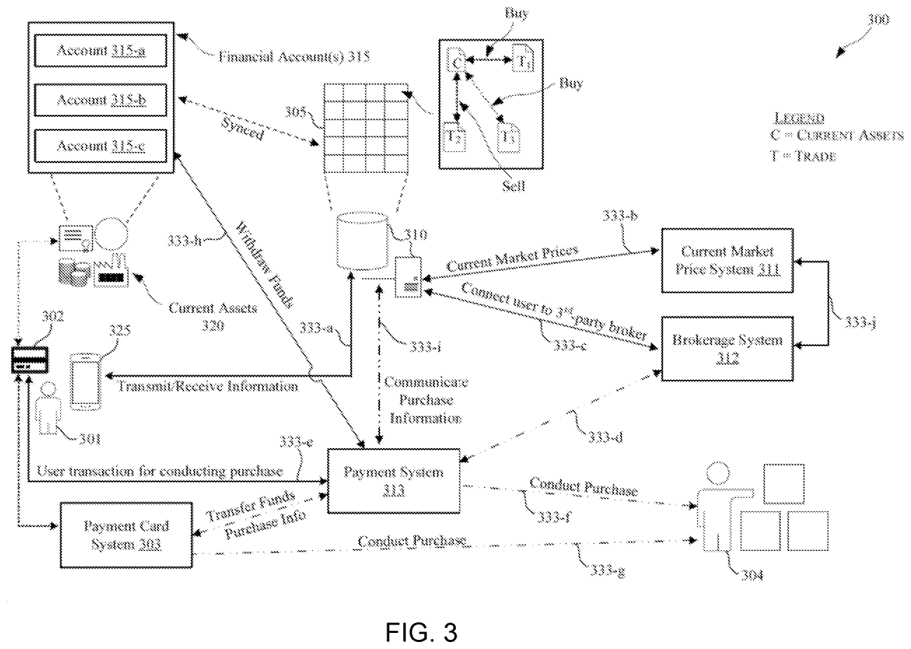

FIG. 1 is a block diagram depicting physical components within a system 100 that may be utilized to settle transaction payments, in accordance with one or more embodiments of the present disclosure. In some embodiments, the system 100 includes one or more server(s) 102. The one or more server(s) 102 may be configured to communicate with one or more client computing platforms (or Remote Platform(s)) 104 according to a client/server architecture and/or other architectures. The one or more client computing platforms 104 may be configured to communicate with other client computing platforms via server(s) 102 and/or according to a peer-to-peer architecture and/or other architectures. Users (shown as user 301 in FIG. 3) may access the system 100 via the one or more client computing platforms 104.

The server(s) 102 may be configured by machine-readable instructions 106. The machine-readable instructions 106 may include one or more instruction modules. The one or more instruction modules may include computer program modules. The one or more instruction modules may include one or more of a user profile module 108, a financial account linking module 110, a payment card module 112, a user transaction request module 114, a notification module 116, a user input module 118, an assets module 120, a fund withdrawing module 122, a broker module 124, a digital ledger module 126, a trade execution module 128, a current market price module 130, a fund transfer module 132, a fractional share trading module 134, a communication module 136, and/or other instruction modules.

The user profile module 108 may be configured to create a user profile for a user 301 in a first network. In some cases, the user profile may include user authentication information, such as, but not limited to, a user name, an email address, a phone number, a unique identifier (e.g., Social Security Number (SSN), last four digits of SSN), a birth date, a biometric identifier of the user 301, a personal identification number (PIN), and/or a passcode (e.g., numeric or alphanumeric passcode). Other types of user authentication information may be used to create the user profile in different embodiments. In some embodiments, the biometric identifier of the user 301 may be acquired by a biometric sensor in the user device (e.g., user device 325 in FIG. 3). Some non-limiting examples of biometric sensors may include a fingerprint sensor, a retina/eye scan sensor, a palm sensor, a digital signature identification sensor, etc. In some cases, the PIN may be a 4-to-6-digit number input by the user 301, for instance, through a keypad, a touch screen or touch sensitive display, etc., of the user device 325. While not necessary, in some examples, the PIN or passcode used to setup the user profile may be the same PIN or passcode used to unlock at least some functionality of the user device 325. In some cases, the user device 325 may include a user authentication processor or module that is electronically, logistically, and communicatively coupled to the biometric sensor. In such cases, the biometric sensor may provide the user 301 biometric data to the user authentication processor/module over a secure (encrypted) communication link. Further, the user authentication processor/module may compare the authentication information to stored authentication information to determine if the user 301 should be authenticated (e.g., if a match is obtained). In other cases, the user authentication processor/module of the user device 325 may communicate the user authentication information (e.g., biometric information) to the user profile module 108 of the system 100, which may then determine if the user 301 is an authorized user 301. In some cases, the user 301 may need to be authenticated at the user device 325, for instance, to trade assets (e.g., sell existing or currently held assets, purchase new assets), receive current market price information for one or more assets, authorize withdrawal of funds from one or more financial accounts, link one or more financial accounts to the user profile, view digital ledger (shown as digital ledger 305 in FIG. 3) information, and/or view financial account(s) balances, to name a few non-limiting examples.

The financial account linking module 110 may be configured to link at least one financial account associated with the user 301 to the user profile, wherein each of the at least one financial account is a third-party financial account in another network different from the first network. In some cases, the third-party financial account may be a checking account with a bank (e.g., BANK OF AMERICA, CHASE, a credit union, etc.). In some embodiments, the app of the present disclosure may directly link to the user's checking account(s). In some cases, the third-party financial account may be a cryptocurrency wallet. The cryptocurrency wallet may be leveraged on a cryptocurrency platform, such as Sila, that stores funds on behalf of the user 301 in a cryptocurrency wallet, such as an Ethereum wallet, on a BlockChain, such as the Ethereum BlockChain. A cryptocurrency, such as a SilaCoin, may be tethered to the United States Dollar and may be treated as third-party financial accounts that have direct cash value to the user 301. The direct cash value may be displayed to the user 301 on the user account and may be used by the user 301 in lieu of a bank account or debit card to purchase assets and potentially receive incoming funds. In some embodiments, the third-party financial account may be an account with a bank funded by deposits from the user 301, either using a debit card or transfer from another third-party financial account. During onboarding, an account may be created for the user 301 with a partnered broker-dealer, a partnered cryptocurrency exchange, or a combination thereof. In this way, the user 301 may only need to log into their existing checking account(s) to set up their user profile. It should be noted that, the broker-dealer and cryptocurrency exchange may be the same or different entities. Said another way, in some cases, a single account (e.g., a third-party brokerage/cryptocurrency account) may be created for the user 301 with the partnered broker-dealer and cryptocurrency exchange (i.e., since they operate as a single entity). Alternatively, during onboarding, a first account (e.g., a third-party brokerage account) may be created for the user 301 with the partnered broker-dealer and a second account (e.g., third-party cryptocurrency account) may be created for the user 301 with the partnered cryptocurrency exchange (i.e., since they operate as distinct and separate entities). In the latter case, both the first and the second accounts may be linked to the at least one financial account (e.g., checking account) associated with the user 301. In some cases, the financial account linking module 110 may allow the user 301 to link multiple financial accounts (e.g., multiple checking accounts), for instance, using their user device 325. In some embodiments, one or more of the financial accounts may require the user 301 to login/authenticate before the financial account can be linked to the user profile. In one non-limiting example, after the user profile is created, the app (e.g., mobile app, web app) of the present disclosure may prompt the user 301 to select which financial accounts they want to link to their user profile. The user 301 may select (e.g., using the touch screen interface of their user device 325) at least one financial account and individually sign in to said financial account so the financial account(s) can be linked to their user profile. In some cases, the app of the present disclosure may display a login/authentication screen for the financial account within a mini-window or sub display within the app, which may allow the user 301 to sign in/authenticate into their financial account. In other cases, the app of the present disclosure may open a browser window on the user device 325 and redirect the user 301 to the login/authentication screen of the financial account provider to link the accounts to the user profile. In some cases, the user 301 may select an option to receive a line of credit issued by a third-party credit lender, and the payment card may allow the user 301 to pay for goods/services using such line of credit. In some cases, the financial account linking module 110 may be configured to provide a secure/encrypted link between the user device 325, the system 100, and the one or more financial account providers so the user's 301 personal and financial data can be secure from interception by rogue parties.

The payment card module 112 may be configured to issue, to the user 301, at least one payment card (shown as payment card 302 in FIG. 3), wherein the at least one payment card 302 comprises one or more of a virtual payment card and a physical payment card. By way of non-limiting example, the at least one payment card 302 is linked to the at least one financial account associated with the user 301. For instance, one of the at least one payment cards 302 may be linked to two financial accounts associated with the user 301, such as a first bank and a second bank, and the payment card 302 may allow the user 301 to pay for goods/services using their account in either of those banks. In some cases, currently used payment cards 302 are specific to a single financial account provider and the user 301 may have to carry multiple, different cards to have access to funds saved in different financial accounts. Aspects of the disclosure allow the user 301 to consolidate/link multiple financial accounts with a single payment card, which not only minimizes the number of payment cards 302 the user 301 has to carry in their wallet, but also facilitates in giving the user 301 greater flexibility in paying for goods/services. In some embodiments, the user 301 may be issued a virtual payment card instantly or almost instantly (e.g., after linking one or more financial accounts to their user profile), where the virtual payment card may be accessed using the app on their user device 325. Further, the user 301 may also be issued a physical payment card, where the physical payment card may be mailed or posted to the address listed on the user profile. In this way, the user 301 may start paying for goods/services using their virtual payment card without having to wait for the physical payment card to arrive.

The user transaction request module 114 may be configured to receive a request for a user transaction, wherein the request is associated with the user 301 using the at least one payment card 302 for conducting a purchase at a vendor (shown as vendor 304 in FIG. 3) (e.g., a POS system at the vendor 304). In some cases, when the user 301 attempts to use their virtual or physical payment card at the vendor 304, a third-party card service (e.g., VISA, MASTERCARD) may transmit a request for the user transaction to the user transaction request module 114. In some cases, the virtual and/or physical payment card may be issued by the third-party card service.

The notification module 116 may be configured to display a timestamped notification on a user device (e.g., shown as user device 325 in FIG. 3) associated with the user 301. In some embodiments, the timestamped notification comprises an indication of current assets (e.g., stocks, cryptocurrency, cash held in a checking or saving accounts, etc.) held by the user 301 that can be used to fund the purchase, an available credit balance issued to the user 301 that can be used to fund the purchase, an indication of a respective account balance for the at least one financial account, or a combination thereof.

The user input module 118 may be configured to accept a user input for conducting the purchase. In some embodiments, the user input module 118 may be configured to work in conjunction with one or more of the other modules of the system 100. For instance, in some cases, conducting the purchase comprises selling at least one asset of the current assets (shown as current assets 320 in FIG. 3) held by the user 301. In such cases, the user input module 118 may instruct the assets module 120 to sell the at least one asset. In some other cases, the user input module 118 may instruct a fund withdrawing module 122 to withdraw funds (shown as communication link 333-h in FIG. 3) from the at least one financial account. In yet other cases, the user input module 118 may instruct a communication module 136 to connect the user 301 to a third-party broker (shown as communication link 333-c in FIG. 3) for purchasing at least one of the one or more first assets and exchanging at least a portion of the at least one of the one or more first assets to fund the purchase. In yet other instances, user input module 118 may be configured to utilize a credit balance available to the user 301 to fund the purchase.

The assets module 120 may be configured to display one or more first assets available to the user 301 for purchase. In some embodiments, the assets module 120 may be further configured to display one or more second assets available for trade by the user 301, wherein the one or more second assets comprise one or more of: the current assets 320 held by the user 301 and the one or more first assets available for purchase by the user 301. In some embodiments, the assets module 120 may be further configured to display a credit balance available to the user 301. By way of non-limiting example, the one or more one or more first and/or second assets available for trade by the user 301 comprise one or more of: stocks, exchange-traded funds (ETFs), commodities, cryptocurrencies, and mutual funds. It should be noted that, the type of assets (e.g., stocks, ETFs, etc.) may be the same or different for the first and second assets. For instance, the first assets available for purchase by the user 301 may include stocks and mutual funds, while the current assets held by the user 301 may include ETFs. In this example, the one or more second assets available for trade by the user 301 may include ETFs, stocks, and mutual funds. In some embodiments, the assets module 120 (or alternatively, the current market price module 130) may be configured to: receive a respective current market price (shown as communication link 333-b in FIG. 3) for at least a portion of the current assets 320 held by the user 301, display the one or more current market prices 333-b to the user 301, and/or lock in the one or more current market prices 333-b for a pre-defined duration (e.g., 1 minute, 5 minutes, etc.). In some cases, the market prices of assets (e.g., stocks, ETFs) are prone to fluctuation, sometimes on a second by second, or minute by minute basis. Locking in the one or more current market prices 333-b for a pre-defined duration may allow the user 301 to purchase (within the pre-defined duration) the assets at the locked in price. In some examples, the system 100 may implement one or more aspects of a server 310 described in relation to FIG. 3. For example, the server 310 may comprise or host one or more of the modules described in relation to FIG. 1. At least one module of the server 310 may be configured to receive a respective current market price for at least a portion of the current assets 320 held by the user 301 from the current market price system 311, for instance. Further, the server 310 may transmit information related to the one or more current market prices 333-b to the user device 325 over communication link 333-a, and the user device 325 may display the one or more current market prices 333-b to the user 301.

The fund withdrawing module 122 may be configured to withdraw funds (shown as communication link 333-h in FIG. 3) from the at least one financial account. In some embodiments, withdrawing funds 333-h from the at least one financial account comprises: communicating, via a third-party payment service, information pertaining to the purchase to a third-party card service and the at least one financial account, wherein the information comprises an indication of the funds required to conduct the purchase, and wherein the at least one payment card 302 is issued by the third-party card service; and transferring the funds required to conduct the purchase from the at least one financial account to the vendor 304 using at least the third-party card service. In some cases, the third-party payment service may own/operate the POS system used by the vendor 304. In some embodiments, the fund withdrawing module 122 (or alternatively, the digital ledger module 126) may be configured to record the transfer of funds from the at least one financial account to the vendor 304 in a digital ledger 305 in the first network, further described below in relation to FIG. 3.

The broker module 124 may be configured to connect the user 301 to a third-party broker 333-c for purchasing at least one of the one or more first assets and exchanging the at least one of the one or more first assets to fund the purchase. In some other cases, the communication module 136 may be configured to connect the user 301 to the third-party broker.

The digital ledger module 126 may be configured to create a digital ledger 305 to record and update the current assets 320 held by the user 301. In some cases, the digital ledger module 126 may also be configured to update a market value of the current assets 320 held by the user 301 in the digital ledger 305 based on the executing the at least one trade. In some embodiments, the digital ledger module 126 may be configured to record the execution of the at least one trade on a digital ledger 305 in the first network, wherein the recording comprises updating the current assets 320 held by the user 301 based on the one or more purchased assets. In some embodiments, the digital ledger module 126 may record the transfer of funds from the at least one financial account to the vendor 304 in a digital ledger 305 in the first network.

The trade execution module 128 may be configured to sell at least one asset of the current assets 320 held by the user 301. By way of non-limiting example, the selling may be based at least in part on the user input module 118 accepting the user input for conducting the purchase (shown as communication links 333-e, 333-f, and 333-g in FIG. 3). In some embodiments, the trade execution module 128 may receive at least one order for trading at least one of the one or more second assets. Further, the trade execution module 128 may be configured to execute, on behalf of the user 301, at least one trade based on the receiving. By way of non-limiting example, executing the at least one trade comprises purchasing the at least one of the one or more first assets, holding the at least one of the one or more first assets purchased in a user brokerage account, wherein the user brokerage account is provided by the third-party broker and is associated with the user 301, and recording the execution of the at least one trade on a digital ledger 305 in the first network, wherein the recording comprises updating the current assets 320 held by the user 301 based on the one or more first assets purchased. In some cases, the trade execution module 128 may work in conjunction with any of the other modules described herein, including one or more of the digital ledger module 126, the user input module 118, the assets module 120, and/or the broker module 124. Additionally, or alternatively, executing the at least one trade may comprise holding the at least one of the first assets purchased in a user cryptocurrency custodial account, where the user cryptocurrency custodial account is provided by a third-party cryptocurrency exchange and is associated with the user 301. It should be noted that, in some instances, the third-party broker or third-party cryptocurrency exchange (as applicable) may technically execute the trade. In such cases, the trade execution module 128 may instruct the third-party broker or the third-party cryptocurrency exchange to execute the trade (e.g., purchase the first assets) on behalf of the user 301.

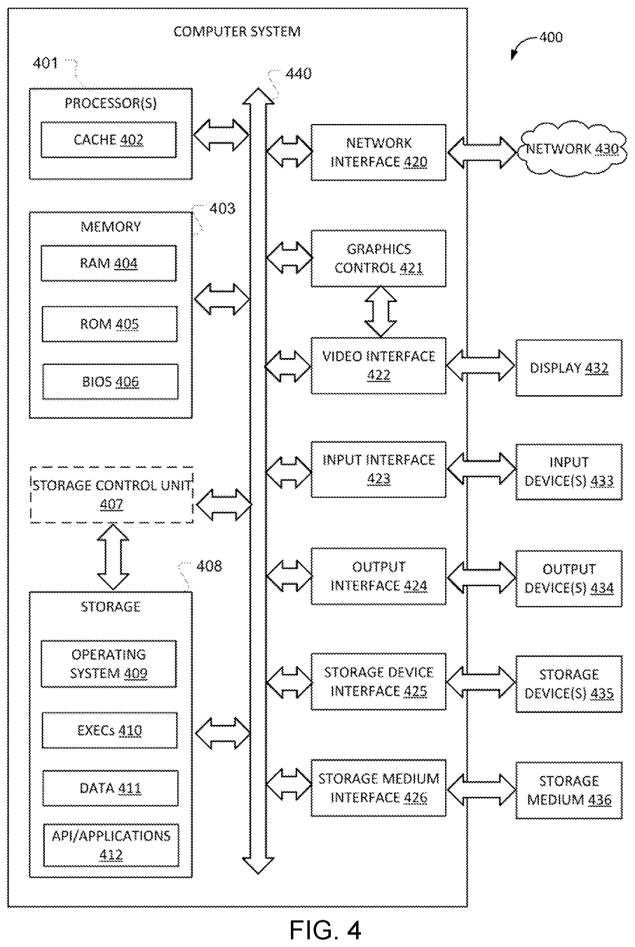

The current market price module 130 may be configured to obtain a current market price 333-b for each of the one or more second assets available for trade by the user 301. The current market price 333-b may be obtained via a third-party service, or alternatively, via the third-party broker linked to the app. In some cases, the third-party broker may include the partnered broker-dealer and/or the partnered cryptocurrency exchange. Further, the current market price module 130 may be configured to display (shown as display 432 in FIG. 4), to the user 301, the one or more current market prices 333-b of the one or more second assets. In some cases, the current market price module 130 (or another module of system 100) may be configured to lock in the one or more current market prices 333-b for a pre-defined duration (e.g., 30 seconds, 1 minute, 2 minutes, 5 minutes, etc.). In some cases, the current market price module 130 may work in conjunction with the trade execution module 128 and/or the assets module 120. For example, the trade execution module 128 and/or the assets module 120 may be configured to purchase or sell, via the third-party broker, an asset associated with the at least one trade based on a locked in current market price 333-b.

The fund transfer module 132 may be configured to transfer the funds required to conduct the purchase from the at least one financial account to the vendor 304 using at least the third-party card service. In some cases, the transfer of funds from the at least one financial account to the vendor 304 (e.g., a financial account owned or operated by the vendor 304) may be recorded in the digital ledger 305 in the first network, for instance, by one or more of the fund transfer module 132 and the digital ledger module 126.

The fractional share trading module 134 may be configured to determine a number of shares or fractional shares of the at least one asset of the current assets 320 needed to conduct the purchase based at least in part on the one or more current market prices 333-b. In some cases, the fractional share trading module 134 may be configured to receive, from the user 301, an indication to sell a respective number of shares or fractional shares of one or more of the at least one asset. Further, the fractional share trading module 134 may be configured to instruct the third-party broker to sell the respective number of shares or fractional shares of the one or more of the at least one asset. In some embodiments, the fractional share trading module 134 (or another module, such as the digital ledger module 126) may be configured to record the sale of the one or more of the at least one asset in the digital ledger 305 in the first network.

The communication module 136 may be configured to connect the user 301 to at least one of a third-party broker (e.g., brokerage system 312 in FIG. 3, partnered broker-dealer) and a third-party cryptocurrency exchange for purchasing at least one of the one or more first assets and exchanging the at least one of the one or more first assets to fund the purchase. In some cases, the third-party broker may include the partnered broker-dealer with which an account was set up during onboarding. Further, the third-party cryptocurrency exchange may include the cryptocurrency exchange with which an account was set up (e.g., during onboarding). In some examples, exchanging the at least one of the one or more first assets may comprise using at least a portion of the proceeds of the sale of the asset(s) to fund the purchase. Additionally, or alternatively, the communication module 136 may be configured to connect the user 301 (e.g., the user device 325 in FIG. 3) to one or more of a third-party service (e.g., current market price system 311 in FIG. 3) and a third-party payment service (e.g., payment system 313, payment card system 303), to name two non-limiting examples.

In some implementations, the first network (e.g., network 150) is one of electronically, logically, and communicatively coupled to each of the other networks, including at least a second network.

In some implementations, the server(s) 102, client computing platforms 104, and/or external resources 138 may be operatively linked via one or more electronic communication links (shown as communication links 333-a to 333-j in FIG. 3). For example, such electronic communication links may be established, at least in part, via a network 150 such as the Internet and/or other networks. It will be appreciated that this is not intended to be limiting, and that the scope of this disclosure includes implementations in which the server(s) 102, client computing platforms 104, and/or external resources 138 may be operatively linked via some other communication media.

A given client computing platform 104 may include one or more processors 142 configured to execute computer program modules. The computer program modules may be configured to enable an expert or user 301 associated with the given client computing platform 104 to interface with the system 100 and/or external resources 138, and/or provide other functionality attributed herein to client computing platforms 104. By way of non-limiting example, the given client computing platforms 104 may include one or more of a desktop computer, a laptop computer, a handheld computer, a tablet computing platform, a NetBook, a Smartphone, a gaming console, and/or other computing platforms.

The external resources 138 may include sources of information outside of the system 100, external entities participating with the system 100, and/or other resources. In some implementations, some or all the functionality attributed herein to the external resources 138 may be provided by resources included in the system 100.

The server(s) 102 may include electronic storage 140, one or more processors 142, and/or other components. The server(s) 102 may include communication lines (not shown), or ports (not shown) to enable the exchange of information with a network and/or other computing platforms. Illustration of the server 102 in FIG. 1 is not intended to be limiting. The server(s) 102 may include a plurality of hardware, software, and/or firmware components operating together to provide the functionality attributed herein to the server(s) 102. For example, the server(s) 102 may be implemented by a cloud of computing platforms operating together as the server(s) 102 or a collection of server(s) 102.

The electronic storage 140 may comprise non-transitory storage media that electronically stores information. The electronic storage media of electronic storage 140 may include one or both of system storage that is provided integrally (i.e., substantially non-removable) with the server(s) 102 and/or removable storage that is removably connectable to the server(s) 102 via, for example, a port (e.g., a USB port, a firewire port, etc.) or a drive (e.g., a disk drive, etc.). The electronic storage 140 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 140 may include one or more virtual storage resources (e.g., cloud storage, a virtual private network, and/or other virtual storage resources). The electronic storage 140 may store software algorithms, information determined by processor(s) 142, information received from the server(s) 102, information received from the client computing platforms 104, and/or other information that enables the server(s) 102 to function as described herein.

The processors 142 may be configured to provide information processing capabilities in the server(s) 102. As such, the processors 142 may include one or more of a digital processor, an analog processor, a digital circuit designed to process information, an analog circuit designed to process information, a state machine, and/or other mechanisms for electronically processing information. Although the processors 142 are shown in FIG. 1 as a single entity, this is for illustrative purposes only. In some implementations, the processors 142 may include a plurality of processing units. These processing units may be physically located within the same device, or the processors 142 may represent processing functionality of a plurality of devices operating in coordination. The processors 142 may be configured to execute modules 108, 110, 112, 114, 116, 118, 120, 122, 124, 126, 128, 130, 132, 134, and/or 136, and/or other modules. The processors 142 may be configured to execute modules 108, 110, 112, 114, 116, 118, 120, 122, 124, 126, 128, 130, 132, 134, and/or 136, and/or other modules by software; hardware; firmware; some combination of software, hardware, and/or firmware; and/or other mechanisms for configuring processing capabilities on the processors 142. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, 134, and/or 136 are illustrated in FIG. 1 as being implemented within a single processing unit, in implementations in which the processors 142 include multiple processing units, one or more of modules 108, 110, 112, 114, 116, 118, 120, 122, 124, 126, 128, 130, 132, 134, and/or 136 may be implemented remotely from the other modules. The description of the functionality provided by the different modules 108, 110, 112, 114, 116, 118, 120, 122, 124, 126, 128, 130, 132, 134, and/or 136 described below is for illustrative purposes, and is not intended to be limiting, as any of modules 108, 110, 112, 114, 116, 118, 120, 122, 124, 126, 128, 130, 132, 134, and/or 136 may provide more or less functionality than is described. For example, one or more of modules 108, 110, 112, 114, 116, 118, 120, 122, 124, 126, 128, 130, 132, 134, and/or 136 may be eliminated, and some or all of its functionality may be provided by other ones of modules 108, 110, 112, 114, 116, 118, 120, 122, 124, 126, 128, 130, 132, 134, and/or 136. As another example, the processors 142 may be configured to execute one or more additional modules that may perform some or all of the functionality attributed below to one of modules 108, 110, 112, 114, 116, 118, 120, 122, 124, 126, 128, 130, 132, 134, and/or 136.

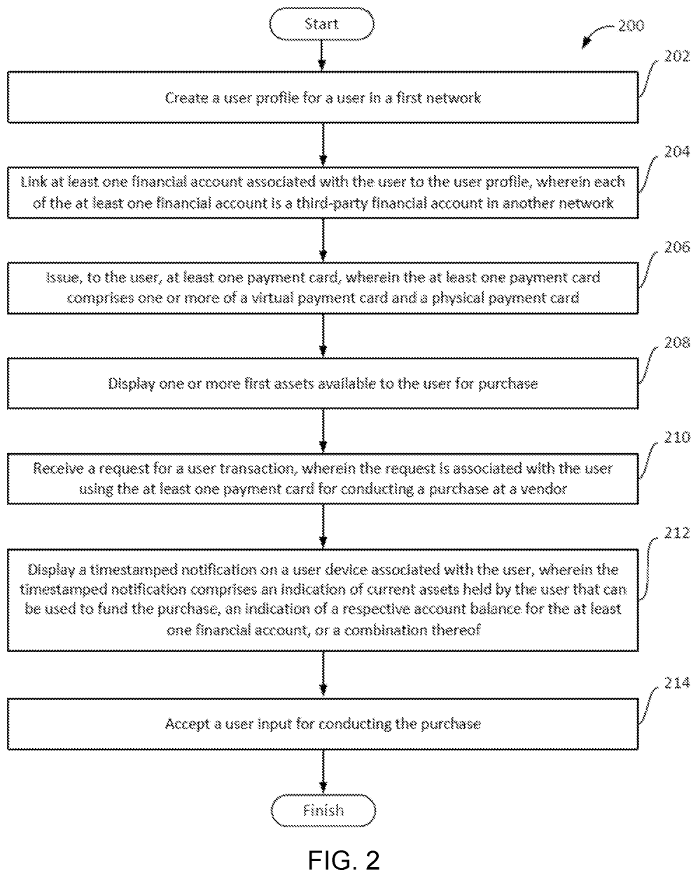

FIG. 2 is a flowchart depicting a method 200 that may be executed for settling transaction payments, in accordance with one or more embodiments of the present disclosure. The operations of the method 200 presented below are intended to be illustrative. In some implementations, the method 200 may be accomplished with one or more additional operations not described, and/or without one or more of the operations discussed. Additionally, the order in which the operations of the method 200 are illustrated in FIG. 2 and described below is not intended to be limiting.

In some implementations, the method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 200 in response to instructions stored electronically on an electronic storage medium. The one or more processing devices may include one or more devices configured through hardware, firmware, and/or software to be specifically designed for execution of one or more of the operations of the method 200.

An operation of the method 200 may include creating a user profile for a user 301 in a first network (e.g., shown as network 150 in FIG. 1) (Block 202). The operation may be performed by one or more hardware processors configured by machine-readable instructions including a module that is the same as or similar to user profile module 108, in accordance with one or more implementations.

A second operation of the method 200 may include linking at least one financial account associated with the user 301 to the user profile, wherein each of the at least one financial account is a third-party financial account in another network different from the first network (Block 204). Some non-limiting examples of financial accounts that may be linked include a bank account (e.g., a checking account), an account with a broker-dealer, and an account with a cryptocurrency exchange. While not necessary, in some embodiments, a third-party broker account and/or a third-party cryptocurrency account may be created during user onboarding (e.g., when the user 301 initially signs up for the service). Further, the second operation may be performed by one or more hardware processors configured by machine-readable instructions including a module that is the same as or similar to financial account linking module 110, in accordance with one or more implementations.

A third operation of the method 200 may include issuing, to the user 301, at least one payment card 302, wherein the at least one payment card 302 comprises one or more of a virtual payment card and a physical payment card (Block 206). The third operation may be performed by one or more hardware processors configured by machine-readable instructions including a module that is the same as or similar to payment card module 112, in accordance with one or more implementations.

A fourth operation of the method 200 may include displaying one or more first assets available to the user 301 for purchase (Block 208). The fourth operation may be performed by one or more hardware processors configured by machine-readable instructions including a module that is the same as or similar to assets module 120, in accordance with one or more implementations.

A fifth operation of the method 200 may include receiving a request for a user transaction, wherein the request is associated with the user 301 using the at least one payment card 302 for conducting a purchase at a vendor 304. The fifth operation may be performed by one or more hardware processors configured by machine-readable instructions including a module that is the same as or similar to user transaction request module 114, in accordance with one or more implementations.

A sixth operation of the method 200 may include displaying a timestamped notification on a user device 325 associated with the user 301, wherein the timestamped notification comprises an indication of current assets held by the user 301 that can be sold to fund the purchase, an indication of the current market price of such assets, an indication of a respective account balance for the at least one financial account, or a combination thereof (Block 212). The sixth operation may be performed by one or more hardware processors configured by machine-readable instructions including a module that is the same as or similar to notification module 116, in accordance with one or more implementations.

A seventh operation of the method 200 may include accepting a user input for conducting the purchase (Block 214). The seventh operation may be performed by one or more hardware processors configured by machine-readable instructions including a module that is the same as or similar to user input module 118, in accordance with one or more implementations. By way of non-limiting example, conducting the purchase comprises one of: selling at least one asset of the current assets held by the user 301; withdrawing funds or using cash held in the user's third-party financial account; and connecting the user 301 to a third-party broker or third-party cryptocurrency exchange for purchasing at least one of the one or more first assets and exchanging the at least one of the one or more first assets to fund the purchase. In some examples, exchanging the at least one of the one or more first assets to fund the purchase may comprise using the proceeds from the sale of the asset(s) to fund the purchase.

FIG. 3 is a block diagram depicting physical components within a system 300 that may be utilized to settle transaction payments between a user 301 and a vendor 304, according to an embodiment of the present disclosure. In some examples, FIG. 3 implements one or more aspects of the figures described herein. As seen, FIG. 3 depicts the user 301, the vendor 304, a user device 325 (e.g., smartphone, laptop, NetBook, etc.) and a payment card 302 associated with the user 301, a server 310, a current market price system 311, a brokerage system 312, a payment system 313, a payment card system 303, one or more financial accounts 315 (e.g., account 315-a, account 315-b, account 315-c) associated with the user 301, and/or current assets 320 associated with the user 301. In some examples, the server(s) 310 may be similar or substantially similar to the server(s) 102 previously described in relation to FIG. 1. Additionally, or alternatively, the server(s) 310 implements one or more aspects of the system 100 described in relation to FIG. 1.

In some embodiments, the user device 325 may be in communication with the server(s) 310 over a communication link 333-a, which may be an example of a wireless communication link. The user device 325 may transmit/receive information from the server(s) 310 over the communication link 333-a, further described below. In some cases, the server(s) 310 may also be in communication with one or more of: current market price system 311 over communication link 333-b, brokerage system 312 over communication link 333-c, and payment system 313 over communication link 333-i. Further, the payment system 313 may be in communication with one or more of: the brokerage system 312 over communication link 333-d, vendor or a POS system operated by the vendor over communication link 333-f, payment card system 303, and one or more financial accounts 315 associated with the user 301 over communication link 333-h. In other cases, the payment system 313 comprises the POS system operated by the vendor. As shown, current market price system 311 and brokerage system 312 may also be in communication over a communication link 333-j. It should be noted that the communication links 333 may be wired or wireless links, such as, but not limited to, ethernet, Wi-Fi, Bluetooth, cellular (e.g., 3G/4G/5G), to name a few non-limiting examples. Further, the server(s) 310 and/or the sub-systems (i.e., current market price system 311, brokerage system 312, payment system 313, payment card system 303, etc.) may be embodied in hardware, software, or a combination thereof.

According to aspects of this disclosure, a system or platform for simplifying a user's wallet is provided which facilitates in giving a user 301 a higher level of flexibility with how they can pay for goods and services. In some cases, the user 301 may be associated with a plurality of financial accounts 315, such as a first bank account (e.g., checking account) with a first financial institution, a second bank account (e.g., checking account) with a second financial institution, a cryptocurrency exchange or wallet account (e.g., Bitcoin) with a third financial institution, a brokerage or trading account with a fourth financial institution, an available line of credit from a third-party credit lender, etc., to name a few non-limiting examples. In some cases, the user 301 may be issued at least one payment card (e.g., debit card, credit card) by a third-party financial institution that is linked to at least one of the one or more financial institutions with which the user 301 has an open account. It should be noted that the payment card(s) issued by the various financial institutions may be different from the virtual/physical payment card issued by the payment card module 112. In some circumstances, the user 301 may not be issued a payment card for at least one of the one or more financial accounts (e.g., cryptocurrency or brokerage/trading account). In some cases, the user 301 may own a plurality of assets in one or more asset classes, including, but not limited to, stocks, exchange-traded funds (ETFs), commodities, cryptocurrencies. The plurality of assets may be held in one or more accounts, for instance, stocks, ETFs, commodities, mutual funds, etc., may be held in a user brokerage account, while cryptocurrencies may be held in a user cryptocurrency custodial account (also referred to as a cryptocurrency or crypto wallet). In some embodiments, one or more of the user brokerage account, the user cryptocurrency custodial account, or the available line of credit may be set up for the user 301 during the onboarding process, and may be linked to the at least one checking account associated with the user 301. Further, the user 301 may also have a portion of their wealth in the form of cash (or funds) saved in their bank account(s). While the user 301 may also own other assets, such as property, vehicles, etc., such assets are not very “liquid”, meaning the user 301 may not be able to easily sell (or liquidate) them to pay for goods or services provided by the vendor 304.

Currently, users 301 carry multiple credit cards, debit cards, etc., in their wallets to pay for goods/services provided by vendors. Alternatively, users 301 pay for goods and services through mobile wallets, such as GOOGLE PAY or APPLE PAY. While mobile wallets are a convenient way for users 301 to pay for items, they still face numerous challenges. For instance, vendors have been slow to adopt mobile wallet technology (e.g., tap and pay using a smartphone), thus requiring users 301 to still carry multiple physical payment cards. Additionally, mobile wallets are usually linked to credit and/or debit cards, thus limiting how users 301 can pay for items. In contrast, aspects of the present disclosure provide a platform for a) simplifying (i.e., reducing) the number of physical payment cards that a user 301 needs to carry and b) allowing a user 301 greater flexibility with regards to the assets they can trade (e.g., sell, exchange) for completing a transaction.

In some cases, the user 301 may download an app (e.g., a mobile app, desktop app, etc.), for instance, from the server 310. After downloading and installing the app on their user device 325, the user 301 may complete the onboarding process (e.g., set up a user profile, link one or more financial accounts 315 and/or brokerage accounts to the user profile, apply for a line of credit available to the user profile). In some cases, the user 301 may then be issued a payment card 302 from the payment card system 303. The payment card system 303 may be associated with a 3rd party payment card service, such as VISA or MASTERCARD. In some examples, the payment card 302 may also be associated with the system (e.g., system 100, system 300, server 310) or app associated with the present disclosure. The payment card 302 may be an example of a virtual card, or alternatively, a physical card. The single payment card 302 may allow the user 301 to complete transactions at the vendor 304 using one or more of the financial accounts 315, a brokerage account associated with brokerage system 312, and/or a cryptocurrency currency account, to name a few non-limiting examples. In some cases, the app downloaded to the user device 325 may allow the user 301 to connect the payment card 302 to the user's financial account(s) 315, such as a 3rd party checking account, and then allow the user 301 to purchase multiple asset classes, including stocks, ETFs, commodities, cryptocurrencies, etc. Further, the user 301 may optionally connect the payment card 302 to a digital wallet provider, such as GOOGLE PAY or APPLE PAY. In some cases, when the user 301 conducts a purchase with the payment card 302, the app may prompt the user 301 to explore how their current asset holdings (e.g., shown as current assets 320) may be used to pay for the purchase. In one non-limiting example, the app may display the intraday price performance of each asset in the current assets 320, along with how much the user 301 would save or lose by using each asset vs cash. For instance, the app may automatically connect the user 301 to a third-party broker (e.g., brokerage system 312) or a third-party cryptocurrency exchange, a payment processor, a custodian, and a pricing service (e.g., current market price system 311). In this way, the user 301 may use a single payment card (e.g., debit card) to pay for items or services at a vendor using a plurality of asset classes, an available line of credit and/or cash in real-time, at the point of sale. In some cases, the current market price system 311 may be optional and the brokerage system (e.g., operated by a broker-dealer) may provide the current market prices for the assets. Similarly, a third-party cryptocurrency exchange may provide the current market price for cryptocurrencies (e.g., Bitcoin, Ethereum, to name two non-limiting examples).

As seen, the user 301 may use the payment card 302 (e.g., a physical card, or alternatively, stored on a virtual/digital wallet) to make a purchase at the vendor 304. In some cases, the payment card 302 may be provided by a third-party debit card provider (e.g., MASTERCARD, VISA, AMERICAN EXPRESS, DISCOVER, etc.). The user 301 may have an app (i.e., provided by the system 300, server 310, etc.) installed on their user device 325, where the app may connect to the user's financial accounts 315 via a third-party provider (not shown). The app may display (e.g., via the user 301 interface of device 325) one or more assets available for purchase by the user 301, as well as their corresponding purchase price. In some cases, the purchase price of the one or more assets may be provided by a third-party pricing service (e.g., current market price system 311). In the example shown, the server 310 (i.e., associated with the app on the user device 325) may receive the current market price information over communication link 333-b and subsequently relay it to the user device 325. In other cases, the user device 325 may directly receive the current market price information from the current market price system 311. As previously noted, the user 301 may buy a plurality of assets, such as, but not limited to, stocks, ETFs, commodities, and cryptocurrencies using the app. The app may automatically place the order with a third-party broker (e.g., brokerage system 312), or a third-party cryptocurrency exchange, which executes the trade and holds the assets in a custodial account. In some embodiments, each asset purchase may be recorded in a digital ledger 305 to match the information held in the custodial account (e.g., a user brokerage custodial account, a user cryptocurrency custodial account). In some embodiments, the digital ledger 305 may be stored on the server 310, although other applicable locations are contemplated in different embodiments. In some examples, the user brokerage custodial account may be provided by the third-party broker and associated with the user 301. Further, the user cryptocurrency custodial account may be provided by the third-party cryptocurrency exchange and associated with the user 301.

In some cases, the current market price(s), or price quote(s), of the asset(s) the user 301 may purchase may be locked in for a set period. For instance, if the user 301 elects to purchase at least one of the one or more assets, the corresponding price quote may be used to establish the purchase price of the assets on the digital ledger 305. Further, the assets may be purchased at the locked in price, where the locked in price may be offered by the brokerage system 312. In some embodiments, current market price system 311 may receive information related to the price offered by the brokerage system 312 over communication link 333-j. When the user 301 confirms the purchase of assets via the app, it automatically places the user's purchase order with the brokerage system 312 at the market price offered by the broker (e.g., over communication links 333-a and 333-c). The assets are then purchased and held in the custodial account and recorded on the digital ledger 305. For instance, after the brokerage system 312 confirms the assets are purchased, the server 310 records information related to the purchase to the digital ledger 305.

FIG. 3 depicts a simplified illustration of the information stored in the digital ledger 305, including current assets information and trade information. In the example shown, the digital ledger 305 shows that the current assets information was updated based on three trades (two buys—T1 and T2; one sell T3), and the three trades were recorded to the digital ledger 305. For instance, trades T1 and T2 led to an increase in the current assets, while T3 lead to a decrease in the current assets. In other words, the current assets information stored in the digital ledger 305 comprises an aggregate of the three trades. After an asset is traded (e.g., bought or sold) by the user 301, the total number of shares (i.e., of the asset) recorded as held by the user 301 on the digital ledger 305 may equal the total number of shares in the custodial account. In some embodiments, the current market value of the user's assets may be frequently updated in the app, for instance, based on the current market price information received from the current market price system 311. The app may update the current market value periodically, for instance, every 5 seconds, 10 seconds, 1 minute, etc. Alternatively, the current market value may be updated based on user 301 request. In some aspects, frequent updating of the current market value of the assets may allow the user 301 to evaluate if/when/which assets to use for vendor purchases.

In some cases, when the payment card 302 is used to make a purchase (e.g., payment system 313 receives a user transaction for conducting purchase over communication link 333-e), a timestamped notification pops up on the user's device 325 showing the user 301 what they could potentially save. For instance, after the user 301 clicks on the notification on their user device 325 (i.e., to open the app), they may view the current value of the assets (e.g., assets 320) they hold that may be used to fund the purchase and how the value of the assets has changed that day based on the current market price, to name two non-limiting examples. Other types of information, such as, a currently held stock that moved above a pre-defined limit, a stock on their watch list that moved below a pre-defined limit, etc., can also be displayed via the app. In this way, if the currently held stock moves above the pre-defined limit, the user 301 may be able to lock in their profit and use a portion of the sale to fund the purchase. Alternatively, the user 301 may sell a certain number of shares corresponding to the profit (i.e., where number of shares to be sold=profit/cost basis, or number of shares=profit/current price) and continue holding on to a portion of the shares. In some aspects, the app may allow the user 301 to have a clearer picture of their savings, assets, etc., since the user 301 has to actively consider the amalgam of different options available (e.g., cash, stocks, ETFs, cryptocurrencies, credit, etc.) to fund each purchase. In another example, at the time of purchase, the app may notify the user 301 that a stock on their watchlist has fallen below a pre-defined limit set by the user 301. In this case, the user 301 may be able to purchase the stock or asset at a lower price (i.e., than when the user 301 added it to the watchlist) and sell one of their currently held assets to fund the purchase. In yet another example, the user 301 may decide to sell a losing asset (e.g., to cover their losses) and use a portion of the sale to fund the purchase. It should be noted that, the example scenarios listed above are not intended to be limiting, and the app may assist the user 301 in making other types of informed choices in different embodiments.

In some cases, if the user 301 elects to use an asset (e.g., a stock) to fund the purchase, the app may utilize current market pricing (e.g., received from current market price system 311, received from the broker-dealer) to determine how many shares of the asset to sell in order to fund the purchase. This share amount (e.g., 10 shares with a current market price of S10) is then sold by the brokerage system 312 or the third-party cryptocurrency exchange. Further, the sale of the assets may then be recorded on the digital ledger 305. In some circumstances, if the user 301 does not select an asset with which to purchase the goods/services after a set period (e.g., 1 minute, 5 minutes, etc.), the purchase may be automatically funded with cash and the user's cash or financial accounts 315 may be debited by the amount of the purchase price. In such cases, server 310 communicates purchase information (e.g., the value of the purchase) to the payment system 313 and instructs the payment system 313 to withdraw funds (or cash) from one or more of the financial accounts 315 to conduct the purchase (e.g., over communication link 333-f). In some embodiments, the payment system 313 withdraws the necessary funds from the financial account(s) 315 over communication link 333-h.

In some embodiments, the third-party card service (e.g., payment card system 303) may handle transaction reconciliation with the vendor 304 and interchange/banking fees by pulling (or withdrawing) funds for the transaction directly from one or more of the financial accounts 315 for each transaction using the payment card 302. In some other cases, the payment card system 303, rather than the payment system 313, conducts the purchase over communication link 333-g. For instance, the payment system 313 transmits purchase information and/or funds to the payment card system 303, following which the payment card system 303 conducts the purchase over communication link 333-g.

FIG. 4 illustrates a diagrammatic representation of one embodiment of a computer system 400, within which a set of instructions can execute for causing a device to perform or execute any one or more of the aspects and/or methodologies of the present disclosure. The components in FIG. 4 are examples only and do not limit the scope of use or functionality of any hardware, software, firmware, embedded logic component, or a combination of two or more such components implementing particular embodiments of this disclosure. Some or all of the illustrated components can be part of the computer system 400. For instance, the computer system 400 can be a general-purpose computer (e.g., a laptop computer) or an embedded logic device (e.g., an FPGA), to name just two non-limiting examples.

Moreover, the components may be realized by hardware, firmware, software, or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

The computer system 400 includes at least one processor(s) 401 (similar to but distinct from the processor(s) 142 in FIG.1) such as a central processing unit (CPU) or a graphics processing unit (GPU) to name two non-limiting examples. Any of the subsystems described throughout this disclosure could embody the processor(s) 401. The computer system 400 may also comprise a memory 403 and a storage 408, both communicating with each other, and with other components, via a bus 440. The bus 440 may also link a display 432, one or more input devices 433 (which may, for example, include a keypad, a keyboard, a mouse, a stylus, etc.), one or more output device(s) 434, one or more storage device(s) 435, and various non-transitory, tangible computer-readable storage medium 436 with each other and/or with one or more of the processor(s) 401, the memory 403, and the storage 408. All of these elements may interface directly or via one or more interfaces or adaptors to the bus 440. For instance, the various non-transitory, tangible computer-readable storage medium 436 can interface with the bus 440 via storage medium interface 426. Computer system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers 102, 310.

The processor(s) 401 (or central processing unit(s) (CPU(s))) optionally contains a cache memory unit (or cache) 402 for temporary local storage of instructions, data, or computer addresses. The processor(s) 401 are configured to assist in execution of computer-readable dinstructions stored on at least one non-transitory, tangible computer-readable storage medium. Computer system 400 may provide functionality as a result of the processor(s) 401 executing software embodied in one or more non-transitory, tangible computer-readable storage media, such as memory 403, the storage 408, storage devices 435, and/or storage medium 436 (e.g., read only memory (ROM)). Memory 403 may read the software from one o more other non-transitory, tangible computer-readable storage media (such as mass storage device(s) 435, 436) or from one or more other sources through a suitable interface, such as network interface 420. Any of the subsystems herein disclosed could include a network interface such as the network interface 420. The software may cause the processor(s) 401 to carry out one or more processes or one or more steps of one or more processes described or illustrated herein. Carrying out such processes or steps may include defining data structures stored in memory 403 and modifying the data structures as directed by the software. In some embodiments, an FPGA can store instructions for carrying out functionality as described in this disclosure. In other embodiments, firmware includes instructions for carrying out functionality as described in this disclosure.

The memory 403 may include various components (e.g., non-transitory, tangible computer-readable storage media) including, but not limited to, a random-access memory component (e.g., RAM 404) (e.g., a static RAM “SRAM”, a dynamic RAM “DRAM”, etc.), a read-only component (e.g., ROM 405), and any combinations thereof. ROM 405 may act to communicate data and instructions unidirectionally to the processor(s) 401, and RAM 404 may act to communicate data and instructions bidirectionally with the processor(s) 401. ROM 405 and RAM 404 may include any suitable non-transitory, tangible computer-readable storage media. In some instances, ROM 405 and RAM 404 include non-transitory, tangible computer-readable storage media for carrying out a method. In one example, a basic input/output system 406 (BIOS), including basic routines that help to transfer information between elements within computer system 400, such as during start-up, may be stored in the memory 403.

The storage 408 is connected bi-directionally to the processor(s) 401, optionally through a storage control unit 407. The storage 408 may be fixed and provide additional data storage capacity and may also include any suitable non-transitory, tangible computer-readable media described herein. The storage 408 may be used to store an operating system 409, EXECs 410 (executables), data 411, API applications 412 (application programs), and the like. Often, although not always, the storage 408 is a secondary storage medium (such as a hard disk) that is slower than primary storage (e.g., memory 403). The storage 408 can also include an optical disk drive, a solid-state memory device (e.g., flash-based systems), or a combination of any of the above. Information in the storage 408 may, in appropriate cases, be incorporated as virtual memory in memory 403.

In one example, storage device(s) 435 may be removably interfaced with computer system 400 (e.g., via an external port connector (not shown)) via a storage device interface 425. Particularly, storage device(s) 435 and an associated machine-readable medium may provide nonvolatile and/or volatile storage of machine-readable instructions, data structures, program modules, and/or other data for the computer system 400. In one example, software may reside, completely or partially, within a machine-readable medium on storage device(s) 435. In another example, software may reside, completely or partially, within the processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 400 may also include an input device 433. In one example, a user 301 of computer system 400 may enter commands and/or other information into computer system 400 via input device(s) 433. Examples of an input device(s) 433 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 433 may be interfaced to bus 440 via any of a variety of input interfaces 423 (e.g., input interface 423) including, but not limited to, serial, parallel, game port, USB, FIREWIRE, THUNDERBOLT, or any combination of the above.

In particular embodiments, when computer system 400 is connected to network 430, computer system 400 may communicate with other devices, such as mobile devices and enterprise systems, connected to network 430. Communications to and from computer system 400 may be sent through network interface 420. For example, network interface 420 may receive incoming communications (such as requests or responses from other devices) in the form of one or more packets (such as Internet Protocol (IP) packets) from network 430, and computer system 400 may store the incoming communications in memory 403 for processing. Computer system 400 may similarly store outgoing communications (such as requests or responses to other devices) in the form of one or more packets in memory 403 and communicated to network 430 from network interface 420. The processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a wide area network (WAN) (e.g., the Internet, an enterprise network), a local area network (LAN) (e.g., a network associated with an office, a building, a campus, or other relatively small geographic space), a telephone network, a direct connection between two computing devices, and any combinations thereof. A network, such as network 430, may employ a wired and/or a wireless mode of communication. In general, any network topology may be used. For example, the wireless communication between the electronic device and the other electronic device may involve conveying packets that are transmitted and received by radios in the electronic device and the other electronic device in accordance with a communication protocol, such as an Institute of Electrical and Electronics Engineers (IEEE) 802.11 standard, Bluetooth, and/or another type of wireless interface, such as a near-field-communication (NFC) standard or specification. In addition, the communication protocol may be compatible with a 3rd generation of mobile telecommunications technology (such as a communication protocol that complies with the International Mobile Telecommunications-2000 specifications by the International Telecommunication Union of Geneva, Switzerland), a 4th generation of mobile telecommunications technology (such as a communication protocol that complies with the International Mobile Telecommunications Advanced specification by the International Telecommunication Union of Geneva, Switzerland), and/or another cellular-telephone communication technique.

Information and data can be displayed through a display 432. Examples of a display 432 include, but are not limited to, a liquid crystal display (LCD), an organic liquid crystal display (OLED), a cathode ray tube (CRT), a plasma display, and any combinations thereof. The display 432 can interface to the processor(s) 401, memory 403, and the storage 408, as well as other devices, such as input device(s) 433, via the bus 440. The display 432 is linked to the bus 440 via a video interface 422, and transport of data between the display 432 and the bus 440 can be controlled via the graphics control 421.

In addition to a display 432, computer system 400 may include one or more other peripheral output device(s) 434 including, but not limited to, an audio speaker, a printer, a check or receipt printer, and any combinations thereof. Such peripheral output devices may be connected to the bus 440 via an output interface 424. Examples of an output interface 424 include, but are not limited to, a serial port, a parallel connection, a USB port, a FIREWIRE port, a THUNDERBOLT port, and any combinations thereof.

In addition, or as an alternative, computer system 400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 400 shown in FIG. 4 such as, but not limited to, the network 430, the processor(s) 401, memory 403, etc., may comprise a cloud computing system. In one such system, front-end systems such as input devices 433 may provide information to back-end platforms such as servers (e.g., computer systems 400, server or computing platform 102) and storage (e.g., memory 403). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users 301 may operate software located on back-end servers through the use of a front-end software application such as, but not limited to, a web browser

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method for settling transaction payments, comprising:
creating a user profile for a user in a first network;
linking at least one financial account to the user profile, wherein one or more of the at least one financial account is a third-party financial account;
issuing at least one payment card to the user, wherein the at least one payment card comprises one or more of a virtual payment card and a physical payment card;
displaying one or more first assets available to the user for purchase on the user profile;
receiving a request from the user to execute a user transaction, wherein the user transaction comprises the user utilizing one or more of the at least one payment card for executing a purchase at a vendor, either physically or virtually;
displaying a timestamped notification on a user device, wherein the timestamped notification comprises an indication of current assets held by the user, an indication of a respective account balance for one or more of the at least one financial account, or a combination thereof;
accepting the request from the user to execute the user transaction, wherein the accepting comprises a user input for executing the purchase at the vendor; and
executing the purchase, wherein executing the purchase comprises of one or more of:
selling at least one asset of the current assets held by the user,
withdrawing funds from the at least one financial account,
connecting the user to a third-party broker or a third-party cryptocurrency exchange for purchasing at least one of the one or more first assets, and
exchanging at least one of the one or more first assets to fund the purchase.

2. The method of claim 1, further comprising:
creating a digital ledger to record and update the current assets held by the user;
displaying one or more second assets available for trade by the user, wherein the one or more second assets comprise one or more of:
the current assets held by the user, and
the one or more first assets available for purchase by the user;
receiving at least one order for trading at least one of the one or more second assets;
executing at least one trade on behalf of the user based on the receiving; and
updating a market value of the current assets held by the user in the digital ledger based on the executing of the at least one trade.

3. The method of claim 2, wherein executing the at least one trade comprises:
purchasing at least one of the one or more first assets;
one of:
holding at least one of the one or more first assets purchased in a user brokerage account, wherein the user brokerage account is provided by the third-party broker and is associated with the user, and
holding at least one of the one or more first assets purchased in a user cryptocurrency custodial account, wherein the user cryptocurrency custodial account is provided by the third-party cryptocurrency exchange and is associated with the user; and
recording the execution of the at least one trade on a digital ledger in the first network, wherein the recording comprises updating the current assets held by the user based on the one or more purchased assets.

4. The method of claim 2, further comprising:
Obtaining a current market price for each of the one or more second assets available for trade by the user via a third-party service or one of the third-party broker or the third-party cryptocurrency exchange;
displaying the one or more current market prices of the one or more second assets to the user; and
locking in the one or more current market prices for a pre-defined duration; and
wherein the executing comprises:
purchasing or selling, via the third-party broker or the third-party cryptocurrency exchange, an asset associated with the at least one trade based on a locked in current market price.

5. The method of claim 2, wherein the one or more second assets available for trade by the user comprise one or more of: stocks, exchange-traded funds, commodities, cryptocurrencies, and mutual funds.

6. The method of claim 1, wherein the at least one payment card is linked to the at least one financial account associated with the user, and wherein withdrawing funds from the at least one financial account comprises:
Communicating information pertaining to the purchase to a third-party card service and the at least one financial account via a third-party payment service, wherein the information comprises an indication of the funds required to conduct the purchase, and wherein the at least one payment card is issued by the third-party card service; and
transferring the funds required to conduct the purchase from the at least one financial account to the vendor using at least the third-party card service.

7. The method of claim 6, further comprising:
recording the transferring of the funds from the at least one financial account to the vendor in a digital ledger in the first network.

8. The method of claim 1, wherein prior to selling the at least one asset of the current assets held by the user, the method comprises:
receiving one or more of current market prices for at least a portion of the current assets held by the user;
displaying the one or more current market prices to the user; and
locking in the one or more current market prices for a pre-defined duration.

9. The method of claim 8, further comprising:
determining a number of shares or fractional shares of the at least one asset of the current assets needed to conduct the purchase based at least in part on the one or more current market prices;
receiving an indication to sell a respective number of shares or fractional shares of one or more of the at least one asset from the user;
instructing the third-party broker to sell the respective number of shares or fractional shares of one or more of the at least one asset; and
recording a sale of one or more of the at least one asset in a digital ledger in the first network.

10. The method of claim 1, wherein the first network is one of electronically, logically, and communicatively coupled to one or more other networks distinct from the first network.

11. A system configured for settling transaction payments, the system comprising:
one or more hardware processors configured by machine-readable instructions to:
create a user profile for a user in a first network;
link at least one financial account associated with the user to the user profile, wherein one or more of the at least one financial account is a third-party financial account in one or more other networks distinct from the first network;
issue at least one payment card to the user, wherein the at least one payment card comprises one or more of a virtual payment card and a physical payment card;
display, on the user profile, one or more first assets available to the user for purchase;
receive a request from the user to execute a user transaction, wherein the user transaction comprises the user utilizing one or more of the at least one payment card for executing a purchase at a vendor, either physically or virtually;
display a timestamped notification on a user device, wherein the timestamped notification comprises an indication of current assets held by the user, an indication of a respective account balance for one or more of the at least one financial account, an indication of an available line of credit, or a combination thereof; and
accept a user input for executing the purchase, wherein executing the purchase comprises of one or more of:
sell at least one asset of the current assets held by the user,
withdraw funds from the at least one financial account,
utilize an available line of credit,
connect the user to a third-party broker or a third-party cryptocurrency exchange for purchasing at least one of the one or more first assets, and
exchange at least one of the one or more first assets to fund the purchase.

12. The system of claim 11, wherein the one or more hardware processors are further configured by machine-readable instructions to:
create a digital ledger to record and update the current assets held by the user;
display one or more second assets available for trade by the user, wherein the one or more second assets comprise one or more of: the current assets held by the user and the one or more first assets available for purchase by the user;
receive at least one order for trading at least one of the one or more second assets;
execute, on behalf of the user, at least one trade based on the receiving; and
update a market value of the current assets held by the user in the digital ledger based on the executing of the at least one trade.

13. The system of claim 12, wherein executing the at least one trade comprises:
purchasing at least one of the one or more first assets;
holding at least one of the one or more first assets purchased in one or more of a user brokerage account and a user cryptocurrency custodial account, wherein the user brokerage account is provided by the third-party broker, and wherein the user cryptocurrency custodial account is provided by the third-party cryptocurrency exchange, and wherein the user brokerage account and the user cryptocurrency custodial account are associated with the user; and
recording the execution of the at least one trade on a digital ledger in the first network, wherein the recording comprises updating the current assets held by the user based on the one or more purchased assets.

14. The system of claim 12, wherein the one or more hardware processors are further configured by machine-readable instructions to:
obtain a current market price for each of the one or more second assets available for trade by the user via a third-party service or one of the third-party broker or the third-party cryptocurrency exchange;
display the one or more current market prices of the one or more second assets to the user; and
lock in the one or more current market prices for a pre-defined duration;
wherein the executing comprises:
purchasing or selling an asset associated with the at least one trade based on a locked in current market price via the third-party broker or the third-party cryptocurrency exchange.

15. The system of claim 12, wherein the one or more second assets available for trade by the user comprise one or more of: stocks, exchange-traded funds, commodities, cryptocurrencies, and mutual funds.

16. The system of claim 11, wherein the at least one payment card is linked to the at least one financial account associated with the user, and wherein withdrawing funds from the at least one financial account comprises:
communicating information pertaining to the purchase to a third-party card service and the at least one financial account via a third-party payment service, wherein the information comprises an indication of the funds required to conduct the purchase, and wherein the at least one payment card is issued by the third-party card service; and
transferring the funds required to conduct the purchase from the at least one financial account to the vendor using at least the third-party card service.

17. The system of claim 16, wherein the one or more hardware processors are further configured by machine-readable instructions to:
record the transfer of funds from the at least one financial account to the vendor in a digital ledger in the first network.

18. The system of claim 11, wherein prior to selling the at least one asset of the current assets held by the user, the one or more hardware processors are configured by machine-readable instructions to:
receive a respective current market price for at least a portion of the current assets held by the user;
display the one or more current market prices to the user; and
lock in the one or more current market prices for a pre-defined duration.

19. A non-transient computer-readable storage medium having instructions embodied thereon, the instructions being executable by one or more processors to perform a method for settling transaction payments, the method comprising:
creating a user profile for a user in a first network;
linking at least one financial account associated with the user to the user profile, wherein each of the at least one financial account is a third-party financial account in another network different from the first network;
issuing at least one payment card to the user, wherein the at least one payment card comprises one or more of a virtual payment card and a physical payment card;
displaying one or more first assets available to the user for purchase;
receiving a request for a user transaction, wherein the request is associated with the user using the at least one payment card for conducting a purchase at a vendor;
displaying a timestamped notification on a user device associated with the user, wherein the timestamped notification comprises an indication of current assets held by the user that can be used to fund the purchase, an indication of a respective account balance for the at least one financial account, an indication of an available line of credit, or a combination thereof; and
accepting a user input for conducting the purchase, wherein conducting the purchase comprises one of:
selling at least one asset of the current assets held by the user;
withdrawing funds from the at least one financial account;
utilizing an available line of credit; and
connecting the user to a third-party broker or a third-party cryptocurrency exchange for purchasing at least one of the one or more first assets and exchanging at least one of the one or more first assets to fund the purchase.

20. The non-transient computer-readable storage medium of claim 19, wherein the method further comprises:
creating a digital ledger to record and update the current assets held by the user;
displaying one or more second assets available for trade by the user, wherein the one or more second assets comprise one or more of: the current assets held by the user and the one or more first assets available for purchase by the user;
receiving at least one order for trading at least one of the one or more second assets;
executing at least one trade based on the receiving on behalf of the user; and
updating a market value of the current assets held by the user in the digital ledger based on the executing the at least one trade.
